(19) United States
(12) Patent Application Publication
(10) Pub. No.: US 2002/0183068 A1
(43) Pub. Date: Dec. 5, 2002

(54) Searching method for mobile terminal

(76) Inventors: Greg Dunko, Cary, NC (US); Jonathan Lohr, Raleigh, NC (US)

Correspondence Address: COATS & BENNETT, PLLC, P O BOX 5, RALEIGH, NC, 27602, US

(21) Appl. No.: 09/841,146

(22) Filed: Apr. 24, 2001

(51) Int. Cl. H04Q 7/20

(52) U.S. Cl. 455/456; 455/457; 455/41

(57) ABSTRACT

A mobile terminal searches for known individuals and acquaintances who may be in the vicinity of the user. A database of individual names and associated search codes is stored in the mobile terminal. Individual names may also be associated with a group. The user selects one or more individuals from the database that the user desires to find. The mobile terminal searches for other compatible devices and exchanges search codes with any found devices. If the search code received from a found device matches a search code for a selected individual or group, the user is notified. The identity of the found party may also be provided to the user as part of the notification.

### BACKGROUND OF THE INVENTION

The present invention relates generally to mobile terminals and, more particularly, to a mobile terminal that searches for and locates specified individuals in the vicinity of the user.

One reason for the popularity of mobile terminals, such as cellular telephones and personal digital assistants (PDAs), is that such devices free the user from tethers to fixed networks. A user can roam freely within a mobile communication network, yet remain in touch with others. Thus, mobile terminals provide a means by which people can remain in contact with whomever they want, wherever they happen to be. The ability to remain in touch with others is particularly useful to groups of people that share a common interest (e.g., families, co-workers, friends, club members).

Several existing technologies facilitate interaction among acquaintances and group members. Internet “chat rooms” and electronic mail (e-mail) are two examples. Internet chat rooms allow members to send live messages in real-time to other chat room participants that are currently logged into the chat server. Some chat software, such as AOL®lnstant Messenger, inform members of a group (called buddies in AOL®Instant Messenger) when other group members are currently logged into the server.

Many mobile terminals implement a service called Short Message Service (SMS), which enables users to transmit and receive short text messages. SMS may be used by acquaintances or group members to send messages to and receive messages from each other. U.S. patent application Ser. No. 09/514,657 filed Feb. 29, 2000, entitled “Method for Facilitating Electronic Communications,” discloses using SMS for a group messaging application. The '657 patent application relates particularly to a method of tracking the status and location of group members.

There may be circumstances when it would be beneficial to a person to know whether an acquaintance or group member is nearby. Current messaging applications do not provide any means of notifying a person when acquaintances are nearby.

### BRIEF SUMMARY OF THE INVENTION

The present invention relates to a mobile terminal that searches for designated individuals in the vicinity of the user and notifies the user when a designated individual is found nearby. A database of individual names and associated search codes is stored within a mobile terminal. Individuals defined in the database may be friends, business associates, or other acquaintances known to the user. Individual names may be associated with a particular group to allow searching for group members, either individually by name or collectively based on a group name or group code. The mobile terminal also stores a search code for the user of the mobile terminal. The user search code is provided to other mobile terminals conducting a search for individuals or acquaintances.

To find a specified individual or group member, the user selects a designated individual or group from the database. The user may be able to select multiple individuals or groups to search for simultaneously. After selecting an individual or group, the corresponding search codes for the selected individuals or groups are loaded into a search list in memory and the mobile terminal begins searching for other compatible devices in the vicinity of the user. A variety of search techniques and methods can be used. For example, the mobile terminal may include a short-range air interface, such as a BLUETOOTH interface. A mobile terminal equipped with a BLUETOOTH interface searches for other BLUETOOTH devices within about a 100 meter radius. When a compatible mobile terminal is found, the found device provides its search code to the searching mobile terminal. The searching mobile terminal compares the search code provided by the found device to the search list containing search codes for the selected individuals and groups. If a match is found, the searching device determines which individual and/or group member is found and notifies the user of the searching device. Any form of notification may be used.

A method of beaming search codes between two mobile terminals is also provided to enable users to easily exchange search codes. When a user desires to share a search code, the user initiates a beaming procedure and selects a particular search code to share. The mobile terminal then searches for other nearby devices. When a compatible mobile terminal is found nearby, a name associated with the found device is provided to the person sharing the search code to assure that the shared code is sent to the correct party. The name associated with more than one found device may be provided as a result of the search. The user sharing the search code selects the devices from a list of found devices with whom the user wants to share the selected search code. After confirming the selection, the mobile terminal transmits or “beams” the selected search code to the found device(s) selected by the user.

### BRIEF DESCRIPTION OF THE DRAWINGS

FIG. 1 is a block diagram of a mobile terminal implementing the search method of the present invention.

FIG. 2 is a flow diagram of an exemplary search procedure employing a database of search codes and corresponding individuals and/or groups.

FIG. 3 is a flow diagram of an exemplary procedure for adding records to the database.

FIG. 4 is a flow diagram of an exemplary procedure for beaming search codes between two mobile terminals.

### DETAILED DESCRIPTION OF THE INVENTION

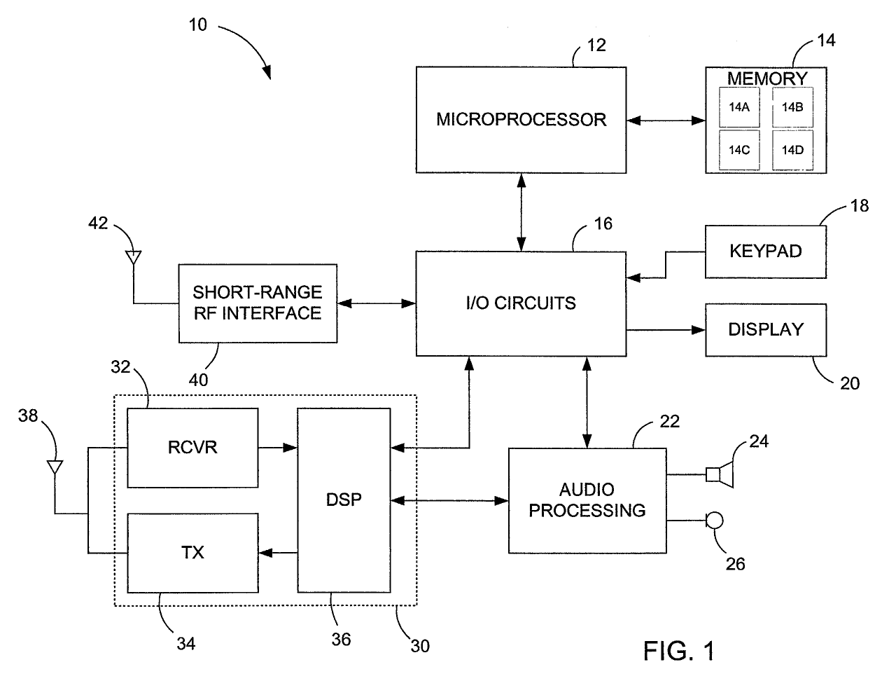

Referring now to FIG. 1, a mobile terminal implementing the search method of the present invention is shown therein and is indicated generally by the numeral 10. Mobile terminal 10 may comprise a cellular radiotelephone; a Personal Communications Service (PCS) terminal that combines a cellular radiotelephone with data processing, facsimile, and data communications capabilities; a Personal Digital Assistant (PDA) that may include a radiotelephone, pager, Internet/intranet access, Web browser, organizer, and/or calendar; a conventional laptop computer, a palmtop computer, or other appliance that includes a radiotelephone transceiver. Mobile terminal 10 may also be referred to as a “pervasive computing” device.

Mobile terminal 10 may employ a wide variety of communication standards and protocols, which are published by organizations such as the Telecommunications Industry Association/Electronics Industry Association (TIA/EIA) and the European Telecommunication Standards Institute (ETSI), including without limitation Time Division Multiple Access (TDMA) standards such as TIA/EIA-136 and the Global System for Mobile Communications (GSM), Code Division Multiple Access (CDMA) standards such as TIA/EIA-95, Wideband Code Division Multiple Access (WCDMA) standards such as cdma2000, Universal Wireless Communications (UWC) 136, satellite communication standards such as Globalstar, and short-range wireless standards such as BLUETOOTH. The details of the communication protocols used by the mobile terminal 10 are not material to the invention.

Mobile terminal 10 comprises a main processor 12 for controlling the operation of the mobile terminal 10 and memory 14 for storing control programs and data used by the mobile terminal 10 during operation. The processor 12 can be any commercially available or custom microprocessor suitable for an embedded application. Memory 14 is representative of the overall hierarchy of memory devices containing the software and data used to implement the functionality of the mobile terminal 10. Memory 14 can include, but is not limited to, the following types of devices: cache, ROM, PROM, EPROM, EEPROM, Flash, SRAM, and DRAM. Memory 14 may hold four major categories of software and data used in the computing device: the operating system 14A; the input/output (I/O) device drivers 14B; the application programs 14C; and the application program data 14D.

The operating system 14A is typically designed for embedded applications and is relatively compact to make the most efficient use of memory 14. One such example of an operating system meeting these criteria is the EPOC operating system sold by Symbian Ltd., Sentinel House, 16 Harcourt St., London W1H 1DS UK, which was developed for portable hand-held computers and can be used in an exemplary embodiment of the present invention.

The I/O device drivers 14B include software routines that are accessed through the operating system 14A by the application programs 14C to communicate with devices such as the display 20, certain components of memory 14, and I/O ports, such as a serial port or infrared (IR) port for transferring data to another device or system.

The application programs 14C comprise the programs that implement the various features of the mobile terminal 10. The application programs may include software to implement features such as e-mail, Internet access, word processing, or contact manager. The static and dynamic data used by the application programs 14C is represented by the application data 14D.

Input/output circuits 16 interface the processor 12 and memory 14 with a keypad 18, display 20, audio processing circuits 22, and transceiver 30. The keypad 18 and display 20 provide a user interface that allows the user to interact with the mobile terminal 10. Keypad 18 allows the user to dial numbers, enter commands and data, and select options. The display 20 allows the operator to see dialed digits, stored information, and output from various applications.

Transceiver 30 may, for example, comprise a fully functional cellular radio transceiver 30 that communicates with a base station (not shown) in a public land mobile network (PLMN). Transceiver 30 typically includes a receiver 32 to receive signals, transmitter 34 to transmit signals, and a digital signal processor 36 for processing signals transmitted and received by the mobile terminal 10. Since transceivers 30 are well-known in the art, further description of the transceiver 30 is omitted for the sake of brevity.

The audio processing circuits 22 provide basic analog audio outputs to a speaker 24 and accept analog audio inputs from a microphone 26. Microphone 26 converts audible sounds, such as voice, into electrical signals that are input to the audio processing circuits 22. The processed audio signals can be transmitted by transmitter 34 or used by an application program in memory 14C. Speaker 24 converts audio signals output by said audio processing circuits 22 into audible sounds that can be heard by the user. The audio signals may be received by receiver 32, generated by an application program in memory 14C, or retrieved from memory 14D.

Mobile terminal 10 may also include a short range RF interface 40, such as a “BLUETOOTH” interface, which may use a separate antenna 42. BLUETOOTH is a universal radio interface in the 2.45 GHz frequency band that enables portable electronic devices to connect and communicate wirelessly via short-range, ad hoc networks. Different BLUETOOTH devices can automatically connect and link up with one another when they come into range to form an ad hoc network referred to in the BLUETOOTH standard as a piconet. The BLUETOOTH standard specifies how mobile terminals 10 can interconnect with one another and with stationary devices, such as desktop computers, printers, scanners, and stationary phones. The BLUETOOTH standard enables seamless communication of data and voice over short-range wireless links between both mobile terminals 10 and fixed devices. Persons interested in various details regarding the BLUETOOTH standard are referred to the article entitled “The BLUETOOTH Radio System” authored by Jaap Haartsen, which can be found in the IEEE Personal Communications, February, 2000, the disclosure of which is incorporated herein by reference. For the purposes of the present invention, only BLUETOOTH features of immediate interest are described herein.

BLUETOOTH devices operate in the unlicensed Industrial-Scientific-Medical (ISM) frequency band at approximately 2.45 GHz. The BLUETOOTH standard employs spread spectrum techniques that provide a high degree of interference immunity and multiple access. In particular, the BLUETOOTH standard employs a spread spectrum technique called frequency hopping to spread a narrowband signal over a wide spectrum of frequencies. This technique spreads a narrowband signal by “hopping” from one frequency to another in a defined sequence in accordance with a pseudo-random code and at a defined hop rate.

Frequency hop systems divide the frequency band into a plurality of hop carriers or frequencies. The BLUETOOTH standard defines seventy-nine hop frequencies with one MHz spacing. A hop channel comprises a defined sequence of frequency hops. A hop channel is divided into 625 microsecond intervals—called slots—each corresponding to a different hop frequency. Thus, the BLUETOOTH device hops from one hop frequency to another, remaining on each hop frequency for a period of 625 microseconds, giving a nominal hop rate of 1,600 hops per second. One packet can be transmitted per slot or hop. Slots within a hop channel are alternately used for transmitting and receiving, which results in a time division duplex (TDD) scheme.

Each hop channel is determined by the hop sequence (the order in which the hop frequencies are visited) and by the phase of the hop sequence. Two or more units sharing the same hop channel form a piconet, where one unit acts as a master—controlling traffic on the piconet—and the remaining units act as slaves. Under the BLUETOOTH standard, the hop sequence is determined by the master units system clock. The slaves use the master identity to select the same hop sequence and add time offsets to their respective native clocks to synchronize to the master unit.

BLUETOOTH devices periodically search for other nearby BLUETOOTH devices. Every BLUETOOTH device is identified by a unique address called the BLUETOOTH device address. A first device referred to as the searching device obtains this address from a second device, referred to as a found device, through a procedure called an “inquiry.” When the searching device transmits an “inquiry” message, BLUETOOTH devices in range of the searching device will respond to the inquiry message. The response includes, inter alia, the BLUETOOTH device address of the found device. The standard has provisions for preventing all of the found devices from responding at the same time. Thus, after the inquiry procedure, the searching device will have the BLUETOOTH device address for all found BLUETOOTH devices within range of the searching device. The searching device may now establish a connection with one or more found BLUETOOTH devices to form a piconet. The procedure for establishing this connection is called “paging.”

A page is always directed towards one device, typically, one of the found devices from which a response to an inquiry was received. However, the paging device may already have the BLUETOOTH device address of the paged BLUETOOTH device without the need for sending an inquiry message to obtain the address. When the paging device sends a page to the paged device, the paged device answers the page and synchronizes itself to the paging device's hop channel, while also offsetting its internal clock. Thus, for that piconet, the paged device becomes a slave unit with respect to the paging device. There may be an optional authentication step in this process if needed or desired. The two devices may then continue communications on the newly established communication link.

The mobile terminal 10 of the present invention includes a search application residing in memory 14C that enables the user to search for acquaintances or other designated individuals who may be nearby. In the exemplary embodiment described below, BLUETOOTH search methods are used to find other mobile terminals 10 in the vicinity of the searching mobile terminal 10. The search application may be a stand-alone application or may be part of a larger application, such as a contact manager application. The search application searches for designated individuals, such as friends or group members, and notifies the user when a designated individual is found nearby.

According to the present invention, a search code database containing individual names and associated search codes is stored within memory 14D of the mobile terminal 10.

Table 1 below shows how the search code database might be structured in one embodiment of the invention.

TABLE 1
SEARCH CODE TABLE

| Search Code | Name | Group |
|---|---|---|
| 1011100110 | John Brown | — |
| 0111010011 | Mike Miller | Skateboard Buddies |
| 1110010110 | — | Skateboard Buddies |
| 1010110011 | Karen Douglas | — |

In the exemplary embodiment shown above, the search database comprises a single table, called the search code table, containing three fields: the search code field, the name field, and the group field. Each row of the table comprises one individual record or group record. The search code field contains a unique code for an individual (e.g. friend or acquaintance) or group defined in the database. As one example, the search code in the search code table may be a 10-bit binary number. Alternatively, the search code may be derived from the name. As one example, the search code may comprise the ASCII code for the name. As another example, the search code could be generated by a code generation function (such as a hash function) operating on the individual name. It is not required that the search codes be all of the same length. The search code may be chosen by the user or, alternatively, may be generated automatically by the application when a new individual record is created.

The name field typically contains a character string or text string (e.g., John Brown) that identifies a particular individual. The character string in the name field will typically comprise a name by which the individual is generally known. The name may, for example, comprise an individuals given name and surname, or may comprise a nickname (e.g., Bonzo). The name field may also be left blank or contain a null value to indicate that the search code identifies a group rather than an individual.

The last field in the search code table is the group field. The group field may contain a character string or text string (e.g., “Skateboard Buddies”) that identifies a particular group of individuals. The group field identifies a group to which an individual belongs. Thus, individual members of a particular group are identified by the same entry in the group field or may simply define a group if the name field is left blank. The group field may be left blank or set to null to indicate that a particular individual is not associated with a group.

Since all search codes in the search code table are unique, each record in the search code table associates a search code with either an individual name, an individual name and group, or a group only. The combination of an individual name and/or group with a search code is referred to herein as a search code association. For convenience, a search code associated with an individual name is sometimes referred to herein as an individual search code. A search code associated with a group, but not an individual, is referred to as a group search code.

The mobile terminal 10 also stores a search code for the user of the mobile terminal 10. The user search code is provided to other mobile terminals 10 conducting a search. The user may have a single search code that the user shares with all of the user's friends and acquaintances. Alternatively, the user could have multiple search codes that are shared with different friends and acquaintances.

The present invention allows searching for both individuals or group members that are contained in the database. To find a specified individual or group member, the user selects an individual and/or group from the database. The user may be able to select multiple individuals and/or groups to search for simultaneously. If a group is selected, the mobile terminal 10 looks up the search code for each individual member of the group. After selecting an individual or group, the corresponding search codes for the selected individuals and/or groups are loaded into a search list in memory 14 and the mobile terminal 10 begins searching for other compatible devices in the vicinity of the user. In one exemplary embodiment, the mobile terminal 10 includes a BLUETOOTH interface 40 and searches for other BLUETOOTH devices within range (i.e., about 100 meters). The search is performed using standard BLUETOOTH search methods to identify compatible BLUETOOTH devices in range that are running the same application. When another compatible BLUETOOTH device is found, a communication link with the found device is established in conventional fashion (e.g., page) and the found device provides its search code to the searching device. Alternatively, the two devices may exchange search codes. The searching mobile terminal 10 compares the received search code provided by the found device to the search list containing search codes for the selected individuals and/or groups. If a match is found, the mobile terminal 10 determines the identity of the matching individual or group and notifies the user of the mobile terminal 10. Any form of notification may be used, such as an audible tone, vibration, or visual notification.

When a designated individual or group member is found, the user may attempt to contact such individual or group member by initiating a phone call, sending an e-mail message or short text message to the found party, or sending text or voice message via the BLUETOOTH interface 40. Text and voice messaging may be incorporated into the same application that performs searching to provide a convenient method of contacting known individuals who may be nearby.

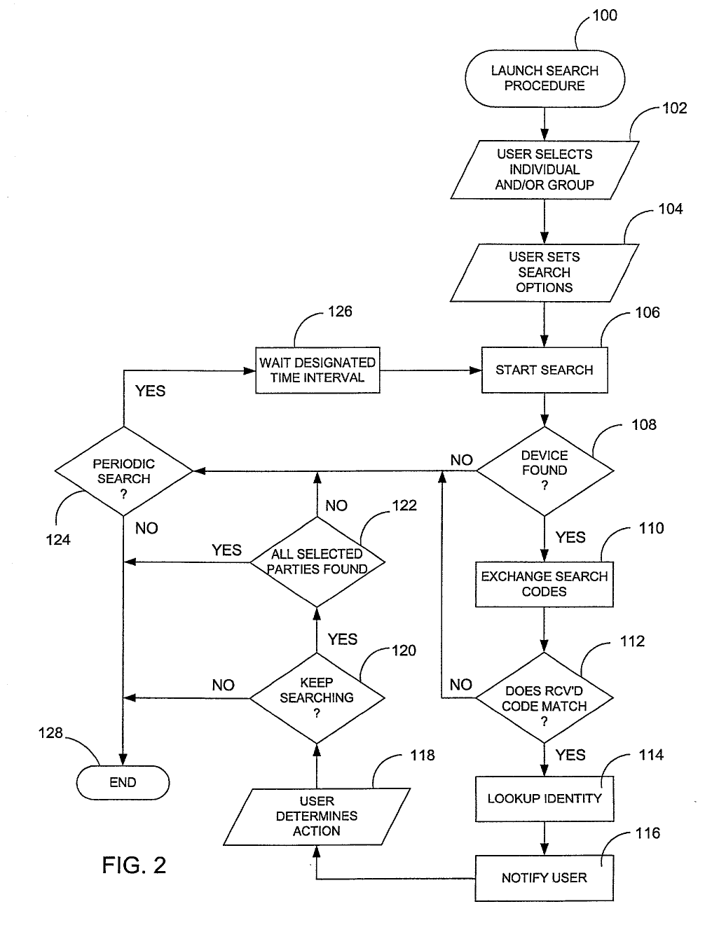

FIG. 2 is a flow diagram illustrating an exemplary search procedure according to one embodiment of the present invention. The search application or procedure is launched at block 100. The user then selects one or more individuals or groups from the database (block 102). Multiple individuals or groups may be selected. The user then has the option of setting search options (block 104). For example, the user may select a one-time search or a periodic search. In the case of a periodic search, the user selects the search period or wait-time between successive searches. After setting the search options, the mobile terminal 10 begins its search for compatible devices using, for example, standard BLUETOOTH search methods (block 106), which are well-known to those skilled in the art. If a compatible device is found (block 108), the mobile terminal 10 exchanges search codes with the found device(s) (block 110) and compares the received search code(s) to the search codes for the selected individuals or groups (block 112). The details of how search codes are exchanged may vary depending upon a particular implementation. If the user of a found device has a single search code, that search code is provided to the searching mobile terminal 10. If the user has multiple search codes, then multiple codes may be provided using an agreed upon method of delimiting multiple search codes. For example, the search codes may be concatenated with a known delimiter separating the multiple search codes. If search codes are all the same length, delimiters can be omitted since the searching mobile terminal 10 will know the number of codes by the length of the received search code string.

If a match is found, the mobile terminal 10 determines the identity of the matching individual or group member (block 114) and notifies the user of the found individual (block 116). Note that if a generic search code for a group, referred to herein as a group search code, is returned, the identity of the individual may not be known. In this case, the mobile terminal 10 simply indicates that a member of a particular group is nearby. The user then determines what action to take (block 118) based on the identity of the found individual or group member. The mobile terminal 10 may prompt the user to keep searching (block 120). The user can then decide whether to continue the search. If the user decides not to continue, the procedure ends (block 128). However, if the user decides to continue searching for additional friends, the mobile terminal 10 then determines whether all the selected parties were found (block 122). If so, the procedure ends (block 128). If not, the mobile terminal 10 checks whether the periodic search option was selected (block 124). If so, the mobile terminal 10 waits the designated time interval (block 126) and repeats the search (block 106) after waiting the selected interval.

If no compatible devices are found in block 108 or no matching search codes are found in block 112, processing proceeds to block 124. If the periodic search option is selected, the mobile terminal 10 waits the designated time interval (block 126) and repeats the search. Otherwise, the search procedure ends (block 128).

In the above described exemplary embodiment, a single table is used to store both individual search codes and group search codes. In an alternate embodiment, two tables could be used: one to store individual search codes and a second table to store group search codes. Tables 2 and 3 below illustrate this alternate table structure for the search code database.

TABLE 2
INDIVIDUAL SEARCH CODE TABLE

| Search Code | Name | Group |
|---|---|---|
| 1011100110 | John Brown | — |
| 0111010011 | Mike Miller | 101101 |
| 1110010110 | Bonzo | 101101 |
| 1010110011 | Karen Douglas | — |

TABLE 3
GROUP SEARCH CODE TABLE

| Search Code | Group Name |
|---|---|
| 101101 | Skateboard Buddies |

The structure of Table 2 is identical to Table 1 with the following distinctions. In the individual search code table shown in Table 2, a blank or null value in the name field is not permitted. Standard validation procedures can be used to assure that this field contains a valid entry. The group field in the individual search code table contains a valid group search code defined in the group search code table (Table 3). In this case, the group search code in the group field is used to indicate the individuals membership in a particular group.

Table 3 shows an exemplary Group Search Code Table that may be used in the individual database to associate a group search code with a group name. The Group Search Code Table comprises two fields: a search code field and a group name field. The search code field contains a unique code for each group that may, for example, be a 6-bit binary number. The group name field contains a text string that identifies the group. An individual in the individual table can be associated with a particular group by including the corresponding group search code in the group field of the individual table, as shown in Table 2.

In this embodiment, a search is performed as shown in FIG. 2. In this case, the found mobile terminal 10 may provide both an individual search code and group search code at block 110. The individual search code may be concatenated with a group search code to enable the searching mobile terminal 10 to search for any member of a specified group. For example, the found device may provide the searching mobile terminal 10 with a 16-bit binary number that comprises a concatenation of a group search code with an individual search code. In this example, the first 6 bits (or the last 6 bits) indicates the group, and the remaining 10 bits (first or last) indicates the individual. A delimiter could be used to delimit the group search code from the individual search code. This would allow multiple group search codes to be concatenated with an individual search code so that the found device could indicate its membership in a plurality of different groups.

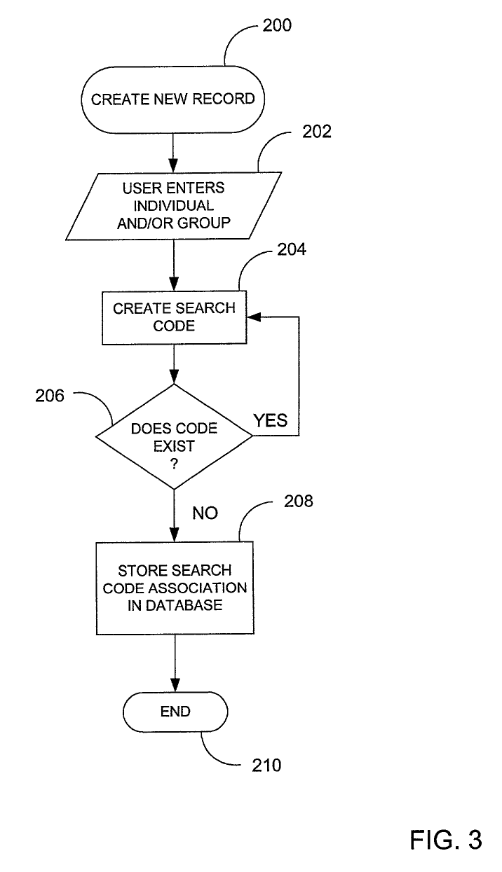

FIG. 3 is an exemplary procedure used in the search application to create a new individual record in the database. At block 200, the user selects the option to create a new individual record and then enters an individual name (block 202). The user may also enter a group name or select an existing group to indicate that the individual is a member of a group. At block 204, a search code is either entered by the user or generated by the application. The newly entered or generated code is compared at block 206 to the already assigned search codes to assure that the new search code is not a duplicate of an already assigned search code. If so, the user is prompted to enter a different search code or a new search code is generated by the application, which is then compared with the existing search codes (block 204). If a manually entered search code is determined to be a duplicate, the mobile terminal 10 notifies the user that the entered search code already exists. The mobile terminal 10 may then give the user the option of manually entering a different search code or allowing the application to generate a different search code. When an available code is found, the individual name, search code, and group name or group code are stored in the database (block 208) to be used for later searching operations and the procedure ends (block 210).

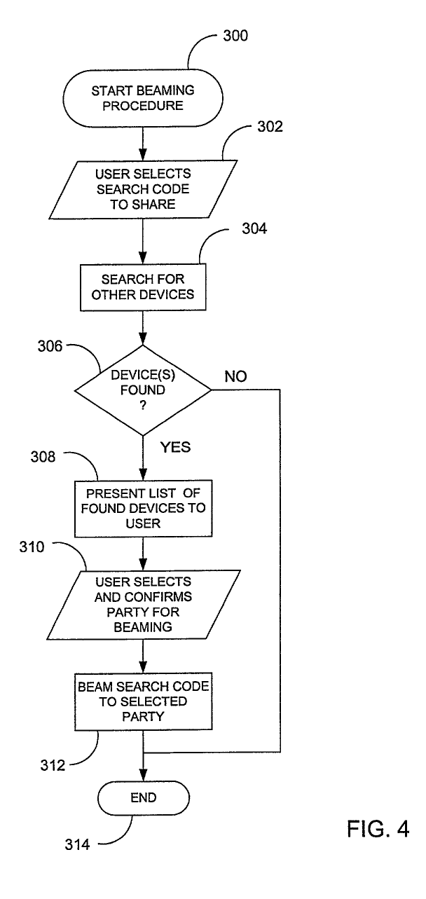

Other methods might also be used to create a new record. For example, a search code association may be “beamed” via the BLUETOOTH interface 40 from one device to another, or may be attached as an object to an SMS or e-mail message. FIG. 4 illustrates an exemplary procedure for “beaming” a search code association between two devices via the BLUETOOTH interface 40. At block 300, the user initiates a beam code procedure and selects a search code to share (block 302). The user may elect to share only the search code, which the receiving mobile terminal 10 must then associate with an individual name to create a search code association. This may be done, for example, when the user is sharing his own search code with a friend. The receiving mobile terminal 10 in this case would prompt the user to enter a name of his or her choosing to associate with the search code. Alternatively, a search code association (e.g., individual name and search code) may be beamed. The search code association may include a group name or group code in addition to a individual name. In this case, the search code association is used to update the database at the receiving mobile terminal 10. This may be done, for example, to share a search code association of a third party so that both mobile terminals 10 involved in the exchange have the same search code association for the third party.

The search code association that is shared may be selected from the database. Alternatively, the sending mobile terminal 10 may be intelligent enough to create a search code association “on the fly” For example, the user of the sending mobile terminal 10 may decide to share his or her own search code with a receiving party. The user chooses his own search code to beam. The application may associate the sender's name with the sender's search code to create a search code association “on the fly” which is then beamed to the receiving party.

After the user selects a search code to share, the mobile terminal 10 searches for compatible devices within range using standard BLUETOOTH search methods (block 304). If other compatible devices are found (block 306), the name of found devices is then provided to the user, typically as a list on display 20 (block 308) to assure that the search code is beamed to the desired party. The user selects one or more found devices from the found device list and confirms the selection (block 310). The selected search codes and/or search code associations are then transmitted via the BLUETOOTH interface 40 to the selected devices (block 312). Use of encryption or other security measures may be used to assure that only the intended party receives the search code. After the “beaming” process is complete, the procedure ends (block 314).

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented in a first mobile terminal of locating specified individuals, said method comprising:
storing a database containing individual names and associated search codes in said mobile terminal;
conducting a search for nearby mobile terminals in the vicinity of said first mobile terminal;
receiving a search code from a found mobile terminal located during said search;
comparing said search code received from said found mobile terminal to one or more stored search codes in said database; and
notifying a user if said search code received from said found mobile terminal matches a stored search code in said database.

2. The method of claim 1 further comprising determining the identity of said found mobile terminal if said search code received from said found mobile terminal matches a stored search code in said database.

3. The method of claim 1 wherein storing a database containing individual names and associated search codes in said mobile terminal comprises storing an individual search code associated with each said individual name in said database.

4. The method of claim 3 wherein storing a database containing individual names and associated search codes in said mobile terminal further comprises storing group search codes, wherein each said group code is associated with one or more individual names in said database.

5. The method of claim 3 wherein receiving a search code from a found mobile terminal comprises receiving an individual search code from said found mobile terminal.

6. The method of claim 4 wherein receiving a search code from a found mobile terminal comprises receiving a group search code from said found mobile terminal.

7. The method of claim 6 wherein comparing said search code received from said found mobile terminal to one or more stored search codes in said database comprises comparing said group search code received from said found mobile terminal to one or more group search codes stored in said database.

8. The method of claim 7 further comprising determining the identity of said found mobile terminal if said group search code received from said found mobile terminal matches one of said group search codes stored in said database.

9. The method of claim 8 wherein determining the identity of said found mobile terminal comprises receiving an individual search code from said found mobile terminal and comparing said individual search code received from said found mobile terminal to said search codes stored in said database to find a matching individual name.

10. The method of claim 1 wherein conducting a search for nearby mobile terminals comprises conducting said search at a periodic interval.

11. The method of claim 1 wherein conducting a search for nearby mobile terminals comprises transmitting a message to said nearby mobile terminals and listening for a response from said nearby mobile terminals.

12. The method of claim 11 wherein transmitting a message to said nearby mobile terminals comprises transmitting said message using a short-range wireless interface.

13. The method of claim 12 wherein said short-range wireless interface is a BLUETOOTH interface.

14. A mobile wireless communication device comprising:
memory for storing a database containing a list of individuals and associated individual search codes;
a user interface to select one or more individuals in said database and to initiate a search for the selected individuals;
a short-range wireless interface to search for and communicate with other nearby mobile terminals;
control logic to compare received search codes received from found mobile terminals to one or more stored search codes in said database and to notify a user of the mobile terminal when a received search code received from a found mobile terminal matches a search code for a selected individual.

15. The mobile terminal of claim 14 wherein said control logic further determines the identity of said found mobile terminal based on said received search code.

16. The mobile terminal of claim 14 wherein one or more individuals in said database are associated with one or more groups.

17. The mobile terminal of claim 16 wherein said groups are identified in said database by a group name.

18. The mobile terminal of claim 17 wherein said groups in said database include an associated group search code.

19. The mobile terminal of claim 18 wherein said selected individuals are identified by the user as members of a selected group.

20. The mobile terminal of claim 19 wherein said control logic compares said received search codes to said group search codes to identify members of said selected group.

21. The mobile terminal of claim 14 wherein said mobile terminal searches for nearby mobile terminals periodically.

22. The mobile terminal of claim 14 wherein said mobile terminal searches for nearby mobile terminals by transmitting a message to said nearby mobile terminals and listening for a response form said nearby mobile terminals.

23. The said mobile terminal of claim 14 wherein said short-range wireless interface comprises a BLUETOOTH interface.
